(19) United States
(12) Patent Application Publication
(10) Pub. No.: US 2013/0164518 A1
(43) Pub. Date: Jun. 27, 2013

(54) RESIN COMPOSITION FOR INJECTION COMPRISING LOW BIREFRINGENCE POLYMER BLEND, AND FRONT PANEL PREPARED USING THE SAME

(71) Applicants: Ik Hwan Cho, Daejeon (KR); Tae Hwa Lee, Bucheon-si (KR); Eung Kee Lee, Gunpo-si (KR); Min Hee Lee, Gunpo-si (KR)

(72) Inventors: Ik Hwan Cho, Daejeon (KR); Tae Hwa Lee, Bucheon-si (KR); Eung Kee Lee, Gunpo-si (KR); Min Hee Lee, Gunpo-si (KR)

(73) Assignee: LG HAUSYS, LTD., Seoul (KR)

(21) Appl. No.: 13/821,794

(22) PCT Filed: Sep. 16, 2011
(86) PCT No.: PCT/KR11/06889

§ 371 Date: Mar. 8, 2013

(30) Foreign Application Priority Data
Sep. 17, 2010 (KR) 10-2010-0091977

(51) Int. Cl. C08L 69/00

(52) U.S. Cl. CPC C08L 69/00
USPC 428/220; 525/133; 524/424

(57) ABSTRACT

The present invention relates to a resin composition for injection including a low birefringence polymer blend, and a front panel prepared using the same, wherein 2-10 parts by weight of a fluidizing agent is added to the composition based on 100 parts by weight of the polymer blend, and the polymer blend comprises 80-90 wt % of a polycarbonate resin and 10-20 wt % of a negative birefringence polymer resin. It is possible to provide an optical panel using the resin composition for injection, wherein the optical panel is mounted on a front panel of a display such as PDP TVs, LCD TVs, borderless TVs or 3D TVs, and comprises a low birefringence polymer blend plastic resin.

### TECHNICAL FIELD

The present invention relates to a resin composition for injection and a front panel prepared using the same, and more particularly to an optical panel mounted on a front side of a display, such as PDP TVs, LCD TVs, borderless TVs and three dimensional TVs, and formed of a low birefringence polymer blend plastic resin.

### BACKGROUND ART

Generally, a cabinet including an edge part is mounted on a front side of a display apparatus, such as liquid crystal display (LCD) TVs. The cabinet includes an opening having a corresponding size to an image display panel in a central area.

Here, the image display panel is coupled to the opening and a glass panel is mounted on a front side of the image output panel to protect the image display panel.

Meanwhile, a borderless glass panel, which does not has a front edge part, is used in response to a recent trend toward a luxurious appearance of a display apparatus.

However, in the borderless front glass panel, it is difficult to form glass and application thereof is not easy due to poor bonding properties to a cabinet.

Furthermore, a front panel is increasingly used for a 3D display. Particularly, a 3D TV may require a pair of 3D glasses, such as a pair of polarizing glasses or a pair of shutter glasses, and thus there is no choice but to use a low birefringence glass panel.

### DISCLOSURE

### Technical Problem

An aspect of the present invention is to provide a resin composition for injection-compression molding in which a high fluidity polymer blend is mixed with an optical compensation additive or a coupling agent, thereby manufacturing a display panel having minimized birefringence.

Another aspect of the present invention is to provide a front panel for a TV which is manufactured by an injection-compression molding method using the composition, thereby minimizing birefringence, being easily applied to a borderless display apparatus, and reducing manufacturing costs.

### Technical Solution

In accordance with one aspect of the present invention, a resin composition for injection includes: 100 parts by weight of a polymer blend and 2 to 10 parts by weight of a fluidizing agent, wherein the polymer blend comprises 80 wt % to 90 wt % of a polycarbonate resin and 10 wt % to 20 wt % of a negative birefringence polymer resin.

Here, the polycarbonate resin may include bisphenol A, which may be copolymerized with at least one of trimethyl-cyclohexyl-bisphenol-A, 3,3,3′,3′-tetramethyl-1,1-spiro-biindane, and fluorene-bisphenol-A.

Further, the polycarbonate resin may have a melt index (MI) of 50 to 60 g/10 min at 300° C.

Next, the negative birefringence polymer resin includes at least one of polystyrene (PS) and dicyclopentadiene (DCPD), wherein the PS may have a molecular weight of 150,000 to 200,000.

Further, the negative birefringence polymer resin may further include at least one of polymethyl methacrylate (PMMA) and polycarbonate of bisphenol having a fluorene structure.

The fluidizing agent may include a low molecular weight compound having a molecular weight of 1,000 to 10,000, and the low molecular weight compound may have negative birefringence.

The resin composition may further include an optical compensation additive and a coupling agent.

The optical compensation additive may include a needle or rod-shaped crystal, for example, SrCO₃.

Here, the optical compensation additive may be present in an amount of 0.5 parts by weight or less based on 100 parts by weight of the polymer blend, and the coupling agent may include Ti based coupling agents.

Another aspect of the present invention provides a front panel for a TV manufactured by injection-compression molding using the resin composition.

Here, the front panel may have a thickness of 3 to 10 mm, and the TV may include any one of an LCD TV, a PDP TV, a borderless TV, and a 3D TV.

### Advantageous Effects

The composition for injection according to the present invention may facilitate manufacture of a panel having both low birefringence and high transmittance.

Thus, the composition for injection according to the present invention enables reduction in manufacturing costs while expanding application ranges thereof.

In addition, a front panel for a TV manufactured using the composition according to the present invention may provide low birefringence and high strength like glass, allows easy molding, and has a light weight, thereby enabling easy application to any one of LCD TVs, PDP TVs, borderless TVs and 3DTVs while facilitating expansion of application ranges thereof.

### DESCRIPTION OF DRAWINGS

FIG. 1 is a cross-sectional view of a front panel for a TV to a display apparatus according to the present invention.

FIGS. 2 and 3 are pictures illustrating birefringence measured after injection-compression molding using injection compositions according to examples of the present invention.

FIGS. 4 to 7 are pictures illustrating birefringence measured after injection-compression molding using injection compositions according to comparative examples.

### BEST MODE

Now, a resin composition for injection including a low birefringence polymer blend and a front panel for a borderless TV prepared using the same according to the present invention will be described in detail with reference to the accompanying drawings.

The above and other aspects, features, and advantages of the invention will become apparent from the detailed description of the following embodiments in conjunction with the accompanying drawings. It should be understood that the present invention is not limited to the following embodiments and may be embodied in different ways, and that the embodiments are provided for complete disclosure and thorough understanding of the invention by those skilled in the art. The scope of the invention is defined only by the claims.

Like components will be denoted by like reference numerals throughout the specification.

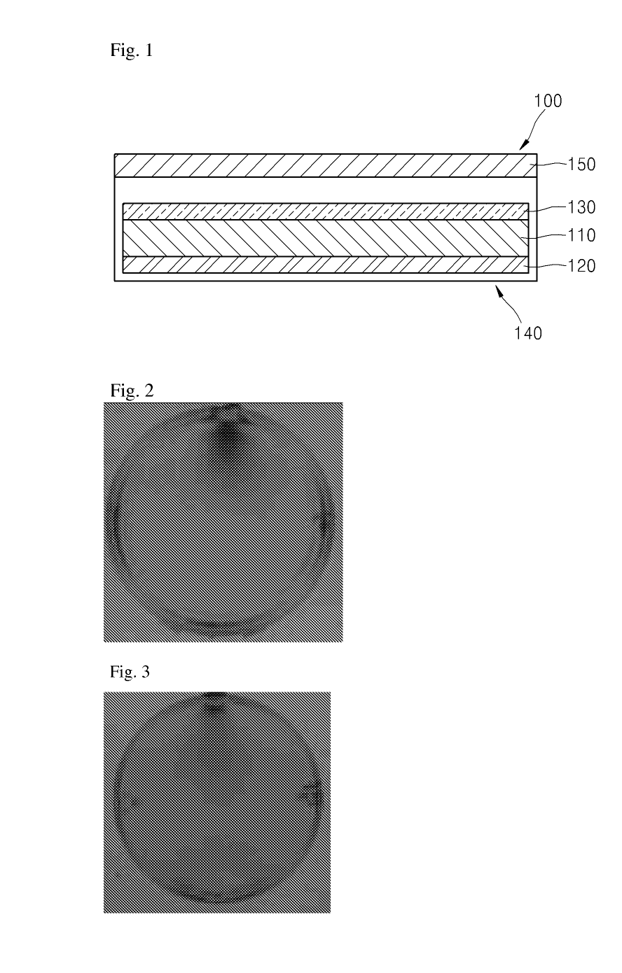

FIG. 1 is a cross-sectional view of a front panel for a TV to a display apparatus according to the present invention.

Referring to FIG. 1, the display apparatus includes a liquid crystal module 110 for a liquid crystal display (LCD) TV and a cabinet 140 that covers the liquid crystal module 110.

Further, the display apparatus 100 includes a front panel 150 manufactured using a resin composition for injection according to the present invention and mounted on the cabinet 140. Here, polarizing plates 120 and 130 for a display may be further provided on upper and lower surfaces of the liquid crystal module 110.

Here, although the display apparatus 100 according to the present invention may be an LCD TV, an LED TV including an LED backlight, a 3D TV including a 3D LCD module, and a PDP may be used.

Here, conventional 3D TVs exhibit double vision or reduced 3D effect or cause dizziness when the front panel 150, an injection-molded product, exhibits birefringence.

However, there is no choice but to use a glass front panel. Meanwhile, when the resin composition according to the present invention is used for a panel, birefringence of the panel is minimized, thus easily applying the panel to the 3D TV.

Further, when a glass panel is used for a front surface of a display apparatus, such as a borderless TV, heavy weight of the panel makes it difficult to fix the panel to the front surface without an additional frame device. Thus, in order to securely apply a panel to the borderless TV, a plastic sheet may be necessary.

Here, an injection-molded product generally exhibits birefringence due to residual stress and orientation in injection. Thus, in order to minimize such birefringence, an injection-compression molding method using polycarbonate (PC) and polymethyl methacrylate (PMMA) is used and processing is carried out as slow as possible.

However, there are limitations in minimizing birefringence even with a molding method or increased processing time. Therefore, the resin composition according to the present invention may enable minimized birefringence regardless of conditions, such as molding method or processing time, being easily applied to a borderless TV or 3D TV.

Next, components of the resin composition for injection according to the present invention and added amounts thereof will be described in detail.

First, the resin composition for injection may include 100 parts by weight of a polymer blend and 2 to 10 parts by weight of a fluidizing agent. Here, the polymer blend may include 80 to 90 wt % of a polycarbonate resin and 10 to 20 wt % of a negative birefringence polymer resin.

Such mixing of the compositions is directed to decreasing birefringence in a stage of adding resin composition raw materials, not in a processing stage, by mixing positive/negative birefringence compositions to offset birefringence of one composition by that of the other composition.

Here, positive/negative birefringence is determined by polarizability difference between a main chain direction of a polymer and a side chain direction thereof. For example, a polycarbonate resin formed of bisphenol A, in which polarizability in a main chain direction of the polymer is greater than polarizability in a side chain direction thereof, has positive birefringence, whereas a polycarbonate resin formed of bisphenol having a fluorene structure with greater polarizability in a side chain of the polymer has negative birefringence.

Thus, the present invention provides a resin composition for injection having minimized birefringence by mixing a polymer blend resin having an adjusted composition of components having different birefringence with a fluidizing agent, optical compensation additives, and the like.

Polycarbonate

As described above, the polycarbonate resin may be formed of bisphenol A having positive birefringence, which may be copolymerized with at least one of trimethyl-cyclohexyl-bisphenol-A,3,3,3′,3′-tetramethyl-1,1-spiro-biindane, and fluorene-bisphenol-A.

Further, the polycarbonate may have a melt index (MI) of 50 to 60 g/10 min at 300° C.

The polycarbonate having the above characteristics may be present in an amount of 80 to 90 wt % to the polymer blend resin.

When the amount of polycarbonate is less than 80 wt %, the resin composition cannot have desired strength for a front panel.

When the amount of polycarbonate is greater than 90 wt %, due to too strong positive birefringence, offsetting birefringence using a negative birefringence resin composition may not properly work.

Further, when the MI of polycarbonate is less than 50 g/10 min at 300° C., the composition exhibits reduced fluidity and too high birefringence due to residual stress and orientation in injection, leaving substantial birefringence even after injection-compression molding.

Although there is no particular restriction as to the MI of polycarbonate, an injection-molded product having excellent strength and impact resistance and low birefringence can be obtained within an MI range less than 60 g/10 min at 300° C.

Negative Birefringence Polymer Resin

Next, the negative birefringence polymer resin may include a polymer resin including at least one of polystyrene (PS) and dicyclopentadiene (DCPD) polymers.

Here, PS may have a molecular weight of 150,000 to 200,000, and such a range may be applied to the entire negative birefringence polymer resin.

Further, the negative birefringence polymer resin may be a resin further including at least one of polymethyl methacrylate (PMMA) and polycarbonate (PC) of bisphenol having a fluorene structure.

The negative birefringence polymer resin having the foregoing properties may be present in an amount of 10 to 20 wt %.

When the amount of the negative birefringence polymer resin is less than 10 wt % or the molecular weight of the negative birefringence polymer resin is less than 150,000, offsetting the positive birefringence of polycarbonate can be insufficient. Further, the amount or the molecular weight of the polymer resin may be determined in view of compatibility.

Meanwhile, when the amount of the negative birefringence polymer resin is greater than 20 wt % or the molecular weight of the negative birefringence polymer resin is greater than 200,000, the composition can exhibit high negative birefringence, resulting in increase in birefringence of an injection-molded product, or have deterioration in compatibility so that the composition may not be applied to optical use.

Fluidizing Agent

Next, the fluidizing agent provides a dense internal structure to a cement curing material to improve water-tightness and resistance to freeze-thawing and to increase durability. The fluidizing agent may include at least one selected from the group consisting of polycarboxylic acids, naphthalenes, melamines and lignins, which may be used alone or as mixtures. However, the fluidizing agent is not limited thereto and may include any fluidizing agent generally used in the art.

Among these, a polycarboxylic acid fluidizing agent is preferably used in view of excellent dispersion. The fluidizing agent is adsorbed onto a surface of cement particles to charge the particle surface and generate repulsion between the particles, thereby dispersing agglomerated particles while increasing flow of the cement particles.

Further, the resin composition for injection according to the present invention may include 2 to 10 parts by weight of the fluidizing agent based on 100 parts by weight of the polymer blend. When the fluidizing agent is excessively added, the fluidizing agent is transferred to the surface of the injection-molded product over time, causing defects and deterioration in mechanical properties of the injection-molded product. When the fluidizing agent is added in a small amount or is not added, fluidity of the polymer resin may deteriorate during injection molding and birefringence may worsen.

Further, the fluidizing agent may be a low molecular weight compound having a molecular weight of 1,000 to 10,000, which has negative birefringence.

Here, when the molecular weight of the low molecular weight compound is less than 1,000, fluidity of the composition can be reduced to increase birefringence of the injection-molded product.

Meanwhile, when the molecular weight of the low molecular weight compound is greater than 10,000, the fluidity of the composition can excessively increase, such that injection-compression molding may not be properly realized.

Optical Compensation Additive and Coupling Agent

The resin composition according to the present invention may further include an optical compensation additive and a coupling agent.

Here, the optical compensation additive may be a needle or rod-shaped crystal, for example, SrCO3.

Here, the optical compensation additive may be present in an amount of 0.5 parts by weight or less based on 100 parts by weight of the polymer blend.

When the amount of the optical compensation additive is greater than 0.5 parts by weight based on 100 parts by weight of the polymer blend, the birefringence of the injection-molded product can increase. Thus, it is preferable to limit the amount of the additive.

Next, the coupling agent may include titanium (Ti) coupling agents.

The Ti based coupling agents increase adhesion between an interface between an inorganic filler and a polymer, thus improving binding power with a polymer matrix and dispersion.

Dispersion increase and viscosity decrease may reduce residual stress in injection and enable high filling to improve moldability.

Now, manufacture of an injection-molded product using the resin composition for injection according to the present invention and birefringence characteristics of the product will be described.

Here, the injection-molded product may be a front panel for any one of an LCD TV, a PDP TV, a borderless TV, and a 3D TV and be formed in a thickness of 3 to 10 mm by an injection-compression molding method.

When the thickness of the panel is less than 3 mm, the front panel cannot have desired strength. When the thickness of the panel is greater than 10 mm, birefringence can increase.

Method of Manufacturing Injection-Molded Product

A polycarbonate resin and a polystyrene resin are first compounded, followed by compounding the resin mixture with SrCO₃ or a fluidizing agent, thereby preparing resin pellets.

The resin pellets are formed into a film using a twin screw extruder and left at 150° C. for 5 minutes, followed by processing the film so that the film has an elongation of 0% and 10% and measuring retardation using a scanner (AXO SCAN). Here, the sample is manufactured using an injection machine.

### EXAMPLE 1

A 3 mm thick panel was manufactured using a resin composition including 100 parts by weight of a polymer blend including 89 wt % of polycarbonate having an MI of 60 g/10 min at 300° C. and 11 wt % of polystyrene having a molecular weight (Mw) of 170,000 and 5 parts by weight of a polycarboxylic acid fluidizing agent having a molecular weight of 1,000, followed by measuring birefringence and retardation of the panel.

### EXAMPLE 2

A 3 mm thick panel was manufactured using a resin composition including 100 parts by weight of the polymer blend of Example 1, 2.5 parts by weight of a polycarboxylic acid fluidizing agent having a molecular weight of 1,000, and 0.1 parts by weight of SrCO₃ as an optical compensation additive, followed by measuring birefringence and retardation of the panel.

### COMPARATIVE EXAMPLE 1

A 3 mm thick panel was manufactured using a resin composition including 89 wt % of polycarbonate having an MI of 30 g/10 min at 300° C. and 11 wt % of polycarbonate including trimethylcyclohexyl bisphenol A, followed by measuring birefringence and retardation of the panel.

### COMPARATIVE EXAMPLE 2

A 3 mm thick panel was manufactured using a resin composition including 89 wt % of polycarbonate having an MI of 60 g/10 min at 300° C. and 11 wt % of polycarbonate including trimethylcyclohexyl bisphenol A, followed by measuring birefringence and retardation of the panel.

### COMPARATIVE EXAMPLE 3

A 3 mm thick panel was manufactured using a resin composition prepared in the same manner as in Example 1 except for the fluidizing agent, followed by measuring birefringence and retardation of the panel.

### COMPARATIVE EXAMPLE 4

A 3 mm thick panel was manufactured using a resin composition including 100 parts by weight of a polymer blend including 79 wt % of polycarbonate having an MI of 30 g/10 min at 300° C. and 21 wt % of polystyrene having a molecular weight (Mw) of 170,000 and 5 parts by weight of a polycarboxylic acid fluidizing agent having a molecular weight of 1,000, followed by measuring birefringence and retardation of the panel.

### COMPARATIVE EXAMPLE 5

A 3 mm thick panel was manufactured using a resin composition including 100 parts by weight of the polymer blend of Example 1 and 15 parts by weight of a polycarboxylic acid fluidizing agent having a molecular weight of 1,000, followed by measuring birefringence and retardation of the panel.

### COMPARATIVE EXAMPLE 6

A 3 mm thick panel was manufactured using a resin composition including 100 parts by weight of the polymer blend of Example 1 and 1 part by weight of a polycarboxylic acid fluidizing agent having a molecular weight of 1,000, followed by measuring birefringence and retardation of the panel.

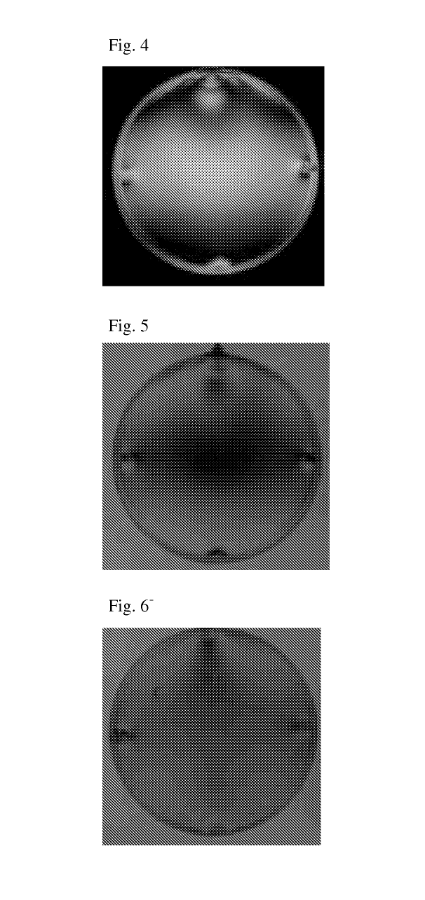

Birefringence results of Examples 1 and 2 and Comparative Examples 1 to 4 are shown in FIGS. 2 to 7 and retardation values thereof are listed in Table 1.

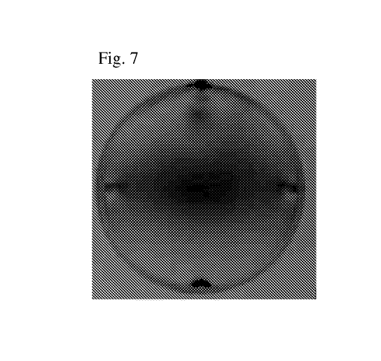

FIGS. 2 and 3 are pictures illustrating birefringence measured after injection-compression molding using the compositions for injection according to the examples of the present invention, and FIGS. 4 to 7 are pictures illustrating birefringence measured after injection-compression molding using the compositions for injection according to the comparative examples.

FIGS. 2 to 7 show high birefringence except for FIG. 2 of Example 1 and FIG. 3 of Example 2.

TABLE 1

Retardation Value

| | Elongation 0% | Elongation 10% |
|---|---|---|
| Example 1 | 5 nm | 230 nm |
| Example 2 | 17 nm | 170 nm |
| Comparative Example 1 | 400 nm | 500 nm |
| Comparative Example 2 | 280 nm | 560 nm |
| Comparative Example 3 | 300 nm | 280 nm |
| Comparative Example 4 | 240 nm | 270 nm |
| Comparative Example 5 | 180 nm | 200 nm |
| Comparative Example 6 | 160 nm | 220 nm |

As described above, the compositions for injection according to the present invention may enable easy manufacture of a panel having both low birefringence and high transmittance, reduce manufacturing costs, and contribute to easily expanding application thereof.

Further, the compositions according to the present invention may provide low birefringence and high strength like glass, be easy to mold, and reduce weight of an injection-molded product, thus being easily applied to any one of LCD TVs, PDP TVs, borderless TVs, and 3D TVs.

Although some embodiments have been provided in conjunction with the drawings, it will be apparent to those skilled in the art that the embodiments are given by way of illustration only, and that various modifications, changes, alterations, and equivalent embodiments can be made without departing from the spirit and scope of the invention. The scope of the invention should be limited only by the accompanying claims.

1. A resin composition for injection comprising:
100 parts by weight of a polymer blend; and
2 to 10 parts by weight of a fluidizing agent,
wherein the polymer blend comprises 80 wt % to 90 wt % of a polycarbonate resin and 10 wt % to 20 wt % of a negative birefringence polymer resin.

2. The resin composition according to claim 1, wherein the polycarbonate resin comprises bisphenol A.

3. The resin composition according to claim 1, wherein the polycarbonate resin is copolymerized with at least one of trimethyl-cyclohexyl-bisphenol-A,3,3,3′,3′-tetramethyl-1,1-spiro-biindane, and fluorene-bisphenol-A.

4. The resin composition according to claim 1, wherein the polycarbonate resin has a melt index (MI) of 50 to 60 g/10 min at 300° C.

5. The resin composition according to claim 1, wherein the negative birefringence polymer resin comprises at least one of polystyrene (PS) and dicyclopentadiene (DCPD).

6. The resin composition according to claim 5, wherein the polystyrene has a molecular weight of 150,000 to 200,000.

7. The resin composition according to claim 5, wherein the negative birefringence polymer resin further comprises at least one of polymethyl methacrylate (PMMA) and polycarbonate of bisphenol having a fluorene structure.

8. The resin composition according to claim 1, wherein the fluidizing agent comprises a low molecular weight compound having a molecular weight of 1,000 to 10,000.

9. The resin composition according to claim 8, wherein the low molecular weight compound has negative birefringence.

10. The resin composition according to claim 1, further comprising an optical compensation additive and a coupling agent.

11. The resin composition according to claim 10, wherein the optical compensation additive comprises a needle or rod-shaped crystal.

12. The resin composition according to claim 11, wherein the optical compensation additive comprises SrCO₃.

13. The resin composition according to claim 10, wherein the optical compensation additive is present in an amount of 0.5 parts by weight or less based on 100 parts by weight of the polymer blend.

14. The resin composition according to claim 10, wherein the coupling agent comprises Ti based coupling agents.

15. A front panel for a TV manufactured by injection-compression molding using the resin composition according to 14 claim 1.

16. The front panel according to claim 15, wherein the front panel has a thickness of 3 mm to 10 mm.

17. The front panel according to claim 15, wherein the TV comprises any one of an LCD TV, a PDP TV, a borderless TV, and a 3D TV.
